(19) United States
(12) Patent Application Publication
(10) Pub. No.: US 2025/0016655 A1
(43) Pub. Date: Jan. 9, 2025

(54) MULTIPATH SETUP METHOD, TERMINAL, AND NETWORK SIDE DEVICE

(71) Applicant: VIVO MOBILE COMMUNICATION CO., LTD., Dongguan (CN)

(72) Inventors: Kimba Dit Adamou BOUBACAR, Dongguan (CN); Jiamin LIU, Dongguan (CN); Qian ZHENG, Dongguan (CN)

(73) Assignee: VIVO MOBILE COMMUNICATION CO., LTD., Dongguan (CN)

(21) Appl. No.: 18/893,932

(22) Filed: Sep. 23, 2024

Related U.S. Application Data
(63) Continuation of application No. PCT/CN2023/082757, filed on Mar. 21, 2023.

(30) Foreign Application Priority Data
Mar. 24, 2022 (CN) 202210303788.8

(51) Int. Cl. H04W 40/22; H04W 40/12; H04W 76/10; H04W 88/04

(52) U.S. Cl. CPC H04W 40/22; H04W 40/12; H04W 76/10; H04W 88/04

(57) ABSTRACT

This application discloses a multipath setup method and related devices. The multipath setup method includes: sending, by a first terminal, target information to a network side device in a case that there is a first path between the first terminal and the network side device; and receiving, by the first terminal, configuration information delivered by the network side device. The target information is used to set up a control plane channel or a user plane channel of a second path; and the configuration information is used to instruct to set up the control plane channel and/or the user plane channel of the second path.

### CROSS-REFERENCE TO RELATED APPLICATIONS

This application is a continuation of International Application No. PCT/CN2023/082757, filed on Mar. 21, 2023, which claims priority to Chinese Patent Application No. 202210303788.8, filed on Mar. 24, 2022. The entire contents of each of the above-referenced applications are expressly incorporated herein by reference.

### TECHNICAL FIELD

This application pertains to the field of communication technologies, and more particularly to a multipath setup method, a terminal, and a network side device.

### BACKGROUND

With rapid development of communication technologies, there is an increasing amount of network information. A user terminal transmits signaling and/or data by setting up a single path (a direct path or an indirect path), but requirements for communication performance in terms of reliability, throughput, and the like cannot be met. Therefore, a multipath setup method that can improve communication performance in terms of reliability, throughput, and the like is urgently needed.

### SUMMARY

Embodiments of this application provide a multipath setup method, a terminal, and a network side device.

According to a first aspect, a multipath setup method is provided. The method is applied to a first terminal and includes:
sending, by a first terminal, target information to a network side device in a case that there is a first path between the first terminal and the network side device, where the target information is used to set up a control plane channel and/or a user plane channel of a second path; and
receiving, by the first terminal, configuration information delivered by the network side device, where the configuration information is used to instruct to set up the control plane channel and/or the user plane channel of the second path.

According to a second aspect, a multipath setup method is provided. The method is applied to a network side device and includes:
receiving, by a network side device, target information sent by a first terminal, where the target information is sent by the first terminal in a case that there is a first path between the first terminal and the network side device, and the target information is used to set up a control plane channel and/or a user plane channel of a second path; and
delivering, by the network side device, configuration information to the first terminal, where the configuration information is used to instruct to set up the control plane channel and/or the user plane channel of the second path.

According to a third aspect, a multipath setup method is provided. The method is applied to a second terminal and includes:
receiving, by a second terminal, target information sent by a first terminal, and forwarding the target information to a network side device, where the target information is sent by the first terminal in a case that there is a first path between the first terminal and the network side device, and the target information is used to set up a control plane channel and/or a user plane channel of a second path; and/or
receiving, by the second terminal, configuration information delivered by the network side device, and forwarding the configuration information to the first terminal, where the configuration information is used to instruct to set up the control plane channel and/or the user plane channel of the second path.

According to a fourth aspect, a multipath setup apparatus is provided, including:
a first sending module, configured to send target information to a network side device in a case that there is a first path between a first terminal and the network side device, where the target information is used to set up a control plane channel and/or a user plane channel of a second path; and
a first receiving module, configured to receive configuration information delivered by the network side device, where the configuration information is used to instruct to set up the control plane channel and/or the user plane channel of the second path.

According to a fifth aspect, a multipath setup apparatus is provided, including:
a second receiving module, configured to receive target information sent by a first terminal, where the target information is sent by the first terminal in a case that there is a first path between the first terminal and a network side device, and the target information is used to set up a control plane channel and/or a user plane channel of a second path; and
a second sending module, configured to deliver configuration information to the first terminal, where the configuration information is used to instruct to set up the control plane channel and/or the user plane channel of the second path.

According to a sixth aspect, a multipath setup apparatus is provided, including:
a first forwarding module, configured to: receive target information sent by a first terminal, and forward the target information to a network side device, where the target information is sent by the first terminal in a case that there is a first path between the first terminal and the network side device, and the target information is used to set up a control plane channel and/or a user plane channel of a second path; and/or
a second forwarding module, configured to: receive configuration information delivered by the network side device, and forward the configuration information to the first terminal, where the configuration information is used to instruct to set up the control plane channel and/or the user plane channel of the second path.

According to a seventh aspect, a first terminal is provided. The terminal includes a processor and a memory, where the memory stores a program or an instruction that can be run on the processor, and the program or the instruction is executed by the processor to implement the steps of the method according to the first aspect.

According to an eighth aspect, a network side device is provided. The network side device includes a processor and a memory, where the memory stores a program or an instruction that can be run on the processor, and the program or the instruction is executed by the processor to implement the steps of the method according to the second aspect.

According to a ninth aspect, a second terminal is provided. The terminal includes a processor and a memory, where the memory stores a program or an instruction that can be run on the processor, and the program or the instruction is executed by the processor to implement the steps of the method according to the third aspect.

According to a tenth aspect, a communication system is provided, including a first terminal, a second terminal, and a network side device. The first terminal may be configured to perform the steps of the multipath setup method according to the first aspect, the network side device may be configured to perform the steps of the multipath setup method according to the second aspect, and the second terminal may be configured to perform the steps of the multipath setup method according to the third aspect.

According to an eleventh aspect, a readable storage medium is provided. The readable storage medium stores a program or an instruction, and the program or the instruction is executed by a processor to implement the steps of the method according to any one of the first aspect to the third aspect.

According to a twelfth aspect, a chip is provided. The chip includes a processor and a communication interface, the communication interface is coupled to the processor, and the processor is configured to run a program or an instruction to implement the steps of the method according to any one of the first aspect to the third aspect.

According to a thirteenth aspect, a computer program/program product is provided. The computer program/program product is stored in a storage medium, and the computer program/program product is executed by at least one processor to implement the steps of the method according to any one of the first aspect to the third aspect.

In embodiments of this application, a first terminal sends target information to a network side device in a case that there is a first path between the first terminal and the network side device, where the target information is used to set up a control plane channel and/or a user plane channel of a second path. The first terminal receives configuration information delivered by the network side device, where the configuration information is used to instruct to set up the control plane channel and/or the user plane channel of the second path. In the embodiments of this application, the control plane channel and/or the user plane channel of the second path may be set up in a case that there is the first path between the first terminal and the network side device, and signaling and/or data are/is transmitted by setting up a multipath, thereby improving communication performance in terms of reliability, throughput, and the like.

### BRIEF DESCRIPTION OF DRAWINGS

FIG. 1 is a block diagram of a wireless communication system to which the embodiments of this application are applicable;

FIG. 2 is a schematic diagram of a typical scenario of a UE-to-network relay mechanism;

FIG. 3 is a schematic flowchart of setting up an RRC connection in a sidelink relay scenario;

FIG. 4a is a first multipath scenario based on an SL relay architecture;

FIG. 4b is a second multipath scenario based on an SL relay architecture;

FIG. 4c is a third multipath scenario based on an SL relay architecture;

FIG. 5a is a first multipath scenario based on an ideal inter-UE connection architecture;

FIG. 5b is a second multipath scenario based on an ideal inter-UE connection architecture;

FIG. 5c is a third multipath scenario based on an ideal inter-UE connection architecture;

FIG. 6 is a first schematic flowchart of a multipath setup method according to an embodiment of this application;

FIG. 7 is a schematic interaction flowchart of a multipath setup method according to an embodiment of this application;

FIG. 8 is a second schematic flowchart of a multipath setup method according to an embodiment of this application;

FIG. 9 is a third schematic flowchart of a multipath setup method according to an embodiment of this application;

FIG. 10 is a first schematic structural diagram of a multipath setup apparatus according to an embodiment of this application;

FIG. 11 is a second schematic structural diagram of a multipath setup apparatus according to an embodiment of this application;

FIG. 12 is a third schematic structural diagram of a multipath setup apparatus according to an embodiment of this application;

FIG. 13 is a schematic structural diagram of a communication device according to an embodiment of this application;

FIG. 14 is a schematic structural diagram of hardware of a first terminal according to an embodiment of this application; and

FIG. 15 is a schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

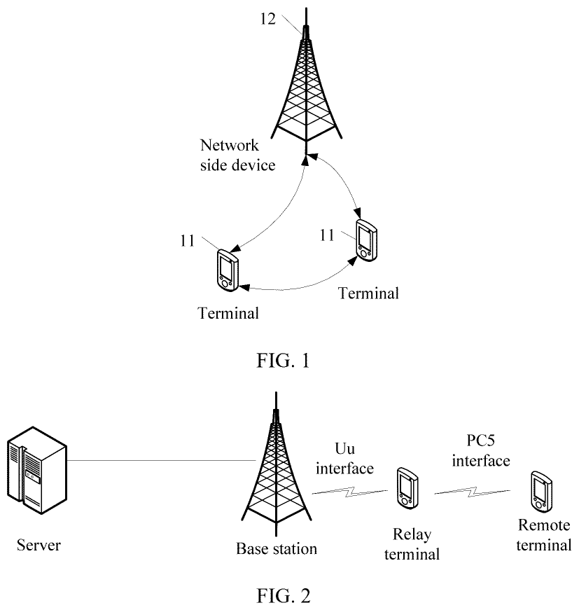

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in a new radio system is used as an example, and a specific type of the base station is not limited.

First, a Sidelink Relay (SL Relay) technology is described as follows:

In a relay technology in a wireless communication system, one or more relay nodes are added between a base station and a terminal to forward a radio signal one or more times, that is, the radio signal can reach the terminal through a plurality of hops. The wireless relay technology can be used not only to extend cell coverage and make up for a blind spot in the cell coverage, but also to improve a cell capacity through spatial resource multiplexing. For indoor coverage, the relay technology can overcome a penetration loss and improve quality of the indoor coverage.

Taking a simple two-hop relay as an example, the wireless relay is to divide a link base station-terminal into two links: base station-relay and relay-terminal, so that a link with relatively poor quality can be replaced with two links with relatively good quality, to obtain a higher link capacity and better coverage. Currently, a relay supported in LTE is a UE-to-network relay, that is, one end of the relay is connected to a terminal, and one end is connected to a network side. The terminal connected to the relay is called a remote terminal (Remote UE).

How to support a terminal-network relay mechanism will also be studied in NR. A typical scenario is shown in FIG. 2. This is a typical terminal-network scenario. A remote terminal needs to transmit data to a network side. However, due to poor coverage, a relay terminal is discovered for forwarding. A Uu interface is used between the relay terminal and a base station, and a sidelink (PC5) interface is used between the relay terminal and the remote terminal. Generally, the relay terminal is open and can serve any remote terminal.

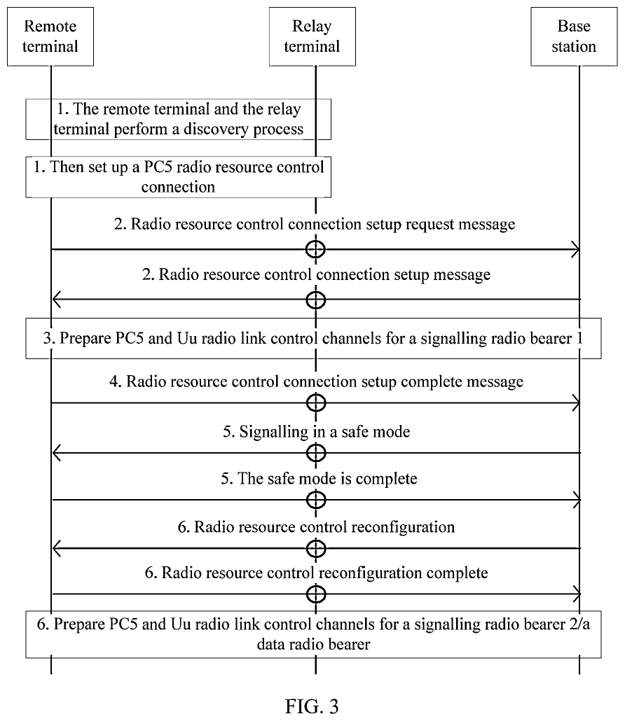

Then, a Radio Resource Control (RRC) connection setup procedure in a sidelink relay scenario is described. As shown in FIG. 3, the procedure includes the following steps:
Step 1: A remote terminal and a relay terminal perform a discovery process, and then set up a PC5 radio resource control connection.
Step 2: The remote terminal sends a radio resource control connection setup request (RRCSetupRequest) message to a base station, and the base station returns a radio resource control connection setup (RRCSetup) message to the remote terminal. Specifically, the two messages are forwarded by the relay terminal to the base station or the remote terminal.
Step 3: A dedicated bearer of a Signaling Radio Bearer (SRB) 1 is set up between the base station and the remote terminal, and the dedicated bearer includes two segments of RLC channels: PC5 (between the remote terminal and the relay terminal) and Uu (between the relay terminal and the base station). Specifically, the two segments of Radio Link Control (RLC) channels are used by the remote terminal to send/receive a radio resource control message of the signaling radio bearer 1 between the remote terminal and the base station.
Step 4: The remote terminal sends a radio resource control connection setup complete (RRCSetupComplete) message to the base station. Specifically, the message is forwarded by the relay terminal to the base station.
Step 5: Security between the remote terminal and the base station is activated. A message and a procedure of the security activation reuse an existing mechanism.
Step 6: A dedicated bearer of a Signaling Radio Bearer (SRB) 2/Data Radio Bearer (DRB) is set up between the base station and the remote terminal, and the dedicated bearer includes two segments of radio link control channels: PC5 (between the remote terminal and the relay terminal) and Uu (between the relay terminal and the base station). Specifically, the two segments of radio link control channels are used by the remote terminal to send/receive a Radio Resource Control (RRC)/Non-access stratum (NAS) message and uplink and downlink service data of the signaling radio bearer 2 between the remote terminal and the base station. Specifically, an existing radio resource control reconfiguration mechanism is reused.

Finally, a multipath scenario is defined as follows:

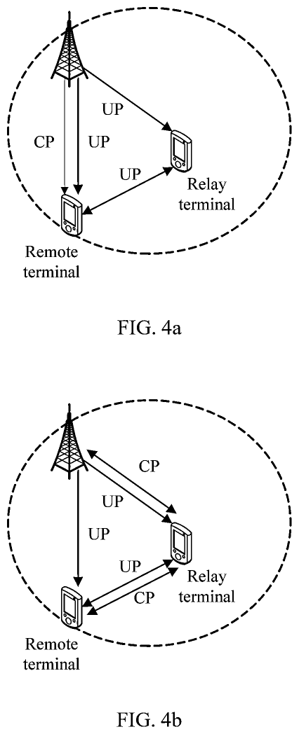

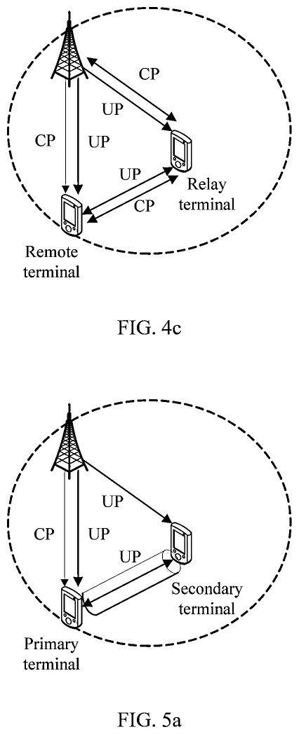

As shown in FIG. 4, for a sidelink relay architecture, multipath means that a remote terminal sets up both an indirect path (indirect path) and a direct path (direct path).

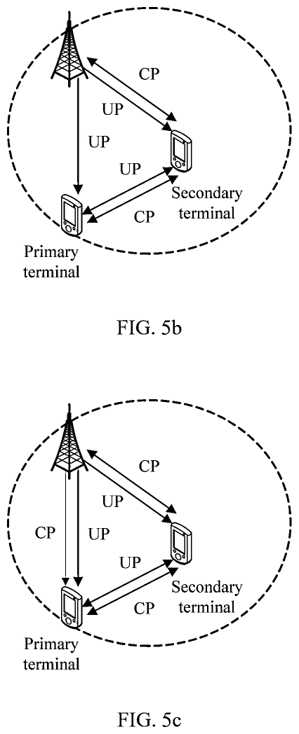

As shown in FIG. 5, for a non-sidelink relay architecture, a connection between two terminals is not a sidelink (PC5) interface, and it is assumed that an interface between the two terminals is a wired connection or an ideal inter-terminal connection (ideal inter-UE connection). Herein, multipath means that a primary terminal (Primary UE) sets up both an indirect path and a direct path.

The indirect path is a radio link in which a remote terminal (or a primary terminal) sets up a radio resource control connection with a base station by using a relay terminal (or a second terminal) and a Uu air interface of the relay terminal (or the second terminal). The direct path is a radio link in which a remote terminal (or a primary terminal) sets up a radio resource control connection with a base station by using a Uu air interface of the remote terminal (or the primary terminal).

With reference to the accompanying drawings, the following describes in detail the multipath setup method provided in the embodiments of this application by using some embodiments and application scenarios thereof.

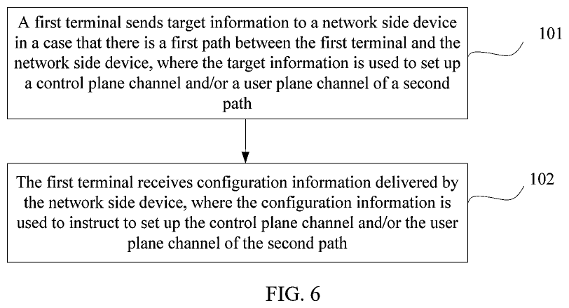

FIG. 6 is a first schematic flowchart of a multipath setup method according to an embodiment of this application. The method provided in this embodiment is implemented based on a multipath scenario in FIG. 4c or a multipath scenario in FIG. 5c. As shown in FIG. 6, the method provided in this embodiment includes the following steps.
Step 101: A first terminal sends target information to a network side device in a case that there is a first path between the first terminal and the network side device, where the target information is used to set up a control plane channel and/or a user plane channel of a second path.

Specifically, the first terminal may be a remote terminal (Remote UE) or a primary terminal (Primary UE), a second terminal may be a relay terminal (Relay UE) or a secondary terminal (Secondary UE), and the network side device may be a base station in a new radio system. The first path may be a direct path, and the second path may be an indirect path; or the first path may be an indirect path, and the second path may be a direct path. Because there is already the first path (a direct path or an indirect path) between the first terminal and the network side device, to set up a multipath, the first terminal actively sends the target information to the network side terminal to set up the control plane channel and/or the user plane channel of the second path (an indirect path or a direct path). Signaling and/or data are/is transmitted by setting up a multipath, thereby improving communication performance in terms of reliability, throughput, and the like.
Step 102: The first terminal receives configuration information delivered by the network side device, where the configuration information is used to instruct to set up the control plane channel and/or the user plane channel of the second path.

Specifically, the network side device delivers the configuration information to the first terminal, where the configuration information is used to instruct to set up the control plane channel and/or the user plane channel of the second path. The first terminal receives the configuration information delivered by the network side device. The configuration information may be carried by using some signaling, for example, sidelink radio bearer configuration (SL-RadioBearerConfig) signaling, data radio bearer configuration (DataRadioBearerConfig) signaling, and Packet Data Convergence Protocol (PDCP) signaling. Signaling and/or data are/is transmitted by setting up a multipath by using the configuration information, thereby improving communication performance in terms of reliability, throughput, and the like.

In this embodiment, in a case that there is the first path between the first terminal and the network side device, the control plane channel and/or the user plane channel of the second path may be set up. Signaling and/or data are/is transmitted by setting up a multipath, thereby improving communication performance in terms of reliability, throughput, and the like.

In an embodiment, the target information includes a request message, and step 101 may be implemented in the following manner:
sending, by the first terminal, the request message to the network side device in a case that there is a control plane channel of the first path between the first terminal and the network side device and a trigger condition of setting up the control plane channel and/or the user plane channel of the second path is met.

In this embodiment, the trigger condition of setting up the control plane channel and/or the user plane channel of the second path is set. If the trigger condition is met, it is considered that a current single path (the control plane channel of the first path) used to transmit signaling and/or data cannot meet requirements for communication performance in terms of reliability, throughput, and the like. In this case, the first terminal actively requests the network side device to set up the control plane channel and/or the user plane channel of the second path. Signaling and/or data are/is transmitted by setting up a multipath, thereby improving communication performance in terms of reliability, throughput, and the like.

For example, the first path is a direct path, the second path is an indirect path, and the trigger condition includes at least one of the following: a measurement result of a direct path is less than a first threshold, a measurement result of an indirect path is greater than a second threshold, to-be-sent uplink data is obtained, and a paging message is received. The measurement result may include at least one of the following: Reference Signal Receiving Power (RSRP) and Reference Signal Receiving Quality (RSRQ).

In the foregoing embodiment, 1. The measurement result of the direct path is less than the first threshold, that is, reliability of the direct path is relatively poor, and the control plane channel and/or the user plane channel of the indirect path need/needs to be set up, so as to improve communication performance in terms of reliability. 2. The measurement result of the indirect path is greater than the second threshold, that is, reliability of the indirect path is relatively good, and the control plane channel and/or the user plane channel of the indirect path may be set up, so as to improve communication performance in terms of reliability. 3. The to-be-sent uplink data is obtained. To avoid a problem that requirements for communication performance in terms of reliability, throughput, and the like cannot be met due to sending of the uplink data by using a single path, the control plane channel and/or the user plane channel of the indirect path need/needs to be set up, so as to improve communication performance in terms of reliability, throughput, and the like. 4. The paging message is received. To avoid a problem that requirements for communication performance in terms of reliability, throughput, and the like cannot be met due to processing of the paging message by using a single path, the control plane channel and/or the user plane channel of the indirect path need/needs to be set up, so as to improve communication performance in terms of reliability, throughput, and the like.

For example, the first path is an indirect path, the second path is a direct path, and the trigger condition includes at least one of the following: a measurement result of a direct path is greater than a first threshold, a measurement result of an indirect path is less than a second threshold, to-be-sent uplink data is obtained, and a paging message is received. The measurement result includes at least one of the following: Reference Signal Received Power (RSRP) and Reference Signal Received Quality (RSRQ).

In the foregoing embodiment, 1. The measurement result of the direct path is greater than the first threshold, that is, reliability of the direct path is relatively good, and the control plane channel and/or the user plane channel of the indirect path may be set up, so as to improve communication performance in terms of reliability. 2. The measurement result of the indirect path is not greater than the second threshold, that is, reliability of the indirect path is relatively poor, and the control plane channel and/or the user plane channel of the indirect path need/needs to be set up, so as to improve communication performance in terms of reliability. 3. The to-be-sent uplink data is obtained. To avoid a problem that requirements for communication performance in terms of reliability, throughput, and the like cannot be met due to sending of the uplink data by using a single path, the control plane channel and/or the user plane channel of the indirect path need/needs to be set up, so as to improve communication performance in terms of reliability, throughput, and the like. 4. The paging message is received. To avoid a problem that requirements for communication performance in terms of reliability, throughput, and the like cannot be met due to processing of the paging message by using a single path, the control plane channel and/or the user plane channel of the indirect path need/needs to be set up, so as to improve communication performance in terms of reliability, throughput, and the like.

In the foregoing embodiment, the sending, by the first terminal, the request message to the network side device may include: sending, by the first terminal, the request message to the network side device by using the first path; or sending, by the first terminal, the request message to the network side device by using the second path.

Specifically, the first terminal may directly send the request message to the network side device by using a direct path; or the first terminal may first send the request message to the second terminal by using an indirect path, and then the second terminal forwards the request message to the network side device by using an indirect path. The request message is sent by using two paths, thereby improving communication performance in terms of reliability, throughput, and the like.

In the foregoing embodiment, before step 101, the method provided in this embodiment further includes: setting up, by the first terminal, a communication connection with a second terminal, where the second path includes a path between the first terminal and the second terminal and a path between the second terminal and the network side device. In this embodiment, the first terminal discovers the second terminal, and sets up the communication connection with the second terminal, so as to set up an indirect path. A manner of setting up the communication connection with the second terminal by the first terminal may include Bluetooth, a wireless network communication technology or Wireless Fidelity (WiFi), a wired manner, a wireless manner, and the like.

For example, the method provided in this embodiment further includes: setting up, by the first terminal, a user plane channel of the first path. In this embodiment, in a case that there is the control plane channel of the first path between the first terminal and the network side device, the first terminal further sets up the user plane channel of the first path, to normally process service data, so that a multipath can be set up without affecting normal processing of the service data.

In another embodiment, step 101 may be implemented in the following manner:
sending, by the first terminal, the target information to the network side device in a case that a measurement result of the first path between the first terminal and the network side device is greater than a fifth threshold.

In this embodiment, if the measurement result of the first path between the first terminal and the network side device is greater than the fifth threshold, it is considered that a current single path (the control plane channel of the first path) used to transmit signaling and/or data cannot meet requirements for communication performance in terms of reliability, throughput, and the like. In this case, the first terminal actively sends the target information to the network side device, to instruct to set up the control plane channel and/or the user plane channel of the second path. Signaling and/or data are/is transmitted by setting up a multipath, thereby improving communication performance in terms of reliability, throughput, and the like.

For example, the target information includes at least one of the following: a measurement result, a Buffer Status Report (BSR), a Sidelink Buffer Status Report (SL BSR), an Uplink Access Indication (UAI), and Sidelink UE Information (SUI).

In the foregoing embodiment, the sending, by a first terminal, target information to a network side device includes: sending, by the first terminal, the target information to the network side device by using the first path; or sending, by the first terminal, the target information to the network side device by using the second path.

Specifically, the first terminal may directly send the target information to the network side device by using a direct path; or the first terminal may first send the target information to the second terminal by using an indirect path, and then the second terminal forwards the target information to the network side device by using an indirect path. The target information is sent by using two paths, thereby improving communication performance in terms of reliability, throughput, and the like.

For example, the receiving, by the first terminal, configuration information delivered by the network side device includes: receiving, by the first terminal, the configuration information delivered by the network side device by using the second path; or receiving, by the first terminal, the configuration information delivered by the network side device by using the first path.

Specifically, the first terminal receives the configuration information delivered by the network side device by using a direct path; or the second terminal first receives the configuration information delivered by the network side device by using an indirect path, and then the second terminal forwards the configuration information to the first terminal. The configuration information is received by using two paths, thereby improving communication performance in terms of reliability, throughput, and the like.

For example, after step 102, the method provided in this embodiment may further include: sending, by the first terminal, configuration complete indication information to the network side device.

Specifically, the first terminal sends the configuration complete indication information to the network side device, and the network side device receives the configuration complete indication information, so as to learn, in a timely manner, that a message that the configuration information has been processed. If the network side device does not receive the configuration complete indication information, the network side device delivers the configuration information to the first terminal again.

For example, the sending, by the first terminal, configuration complete indication information to the network side device includes: sending, by the first terminal, the configuration complete indication information to the network side device by using the first path; or sending, by the first terminal, the configuration complete indication information to the network side device by using the second path.

Specifically, the first terminal sends the configuration complete indication information to the network side device by using a direct path; or the first terminal first sends the configuration complete indication information to the second terminal by using an indirect path, and then the second terminal forwards the configuration complete indication information to the network side device. The configuration complete indication information is sent by using two paths, thereby improving communication performance in terms of reliability, throughput, and the like.

For example, the method provided in this embodiment further includes: determining, by the first terminal, a target path according to a measurement result of the first path and/or the second path, and releasing the target path.

Specifically, for the foregoing embodiment in which the target information includes the request message, after a multipath is configured, the first terminal determines the target path with relatively poor reliability according to the measurement result of the first path and/or the second path, and releases the target path, thereby improving communication performance in terms of reliability.

For example, the determining, by the first terminal, a target path according to a measurement result of the first path and/or the second path includes: in a case that the measurement result of the first path is less than a third threshold, determining, by the first terminal, that the first path is the target path; or in a case that the measurement result of the second path is greater than a fourth threshold, determining, by the first terminal, that the first path is the target path.

Specifically, in a case that the measurement result of the first path is less than the third threshold, that is, reliability of the first path is relatively poor, the first terminal determines that the first path with relatively poor reliability is the target path; or in a case that the measurement result of the second path is greater than the fourth threshold, that is, reliability of the second path is relatively good, the first terminal reserves the second path with relatively good reliability, and determines that the first path is the target path.

For example, the method provided in this embodiment further includes: receiving, by the first terminal, a path switching instruction delivered by the network side device, where the path switching instruction is used to instruct the first terminal to switch a path used for current data transmission from the first path to the second path or switch a path used for current data transmission from the second path to the first path.

Specifically, the first terminal receives the path switching instruction delivered by the network side device, and switches, according to the path switching instruction, the path used for the current data transmission from a path with relatively poor reliability to a path with relatively good reliability, thereby improving communication performance in terms of reliability.

For example, the method provided in this embodiment further includes: releasing or suspending, by the first terminal, the first path in a case that the path used for the current data transmission is switched from the first path to the second path; or releasing or suspending, by the first terminal, the second path in a case that the path used for the current data transmission is switched from the second path to the first path.

Specifically, after the path used for the current data transmission is switched from a path with relatively poor reliability to a path with relatively good reliability, the path with relatively poor reliability is released or suspended, thereby saving data transmission resources.

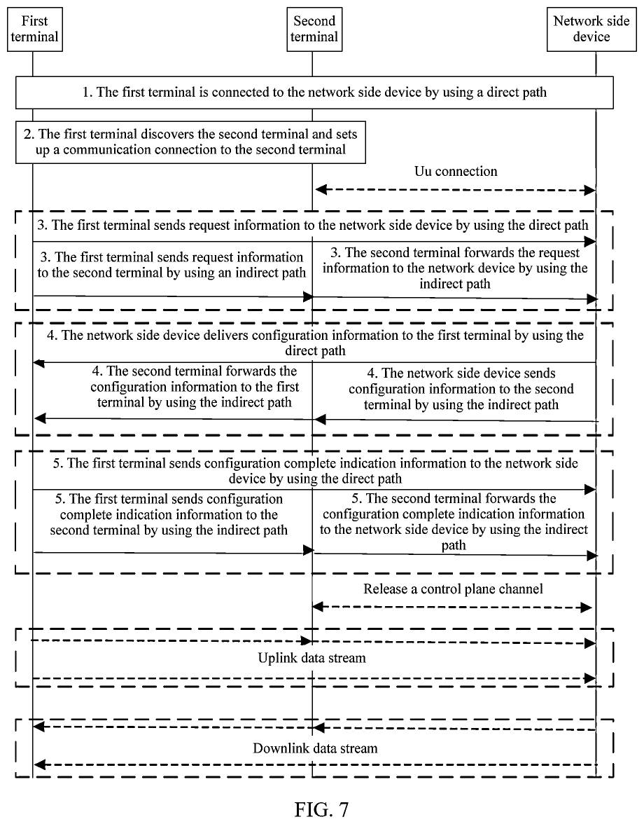

FIG. 7 is a schematic interaction flowchart of a multipath setup method according to an embodiment of this application. As shown in FIG. 7, the method provided in this embodiment includes the following steps.
Step 1: A first terminal sets up a communication connection with a network side device by using a direct path.
Step 2: The first terminal discovers a second terminal and sets up a communication connection with the second terminal.
Step 3: The first terminal sends request message to the network side device by using the direct path or an indirect path, where the request message is used to set up a control plane channel and/or a user plane channel of the indirect path.
Step 4. The network side device delivers configuration information to the first terminal by using the direct path or the indirect path, where the configuration information is used to instruct to set up the control plane channel and/or the user plane channel of the second path.
Step 5. The first terminal sends configuration complete indication information to the network side device by using the direct path or the indirect path.

In this embodiment of this application, the control plane channel and/or the user plane channel of the indirect path may be set up in a case that there is the direct path between the first terminal and the network side device. Signaling and/or data are/is transmitted by setting up a multipath, thereby improving communication performance in terms of reliability, throughput, and the like.

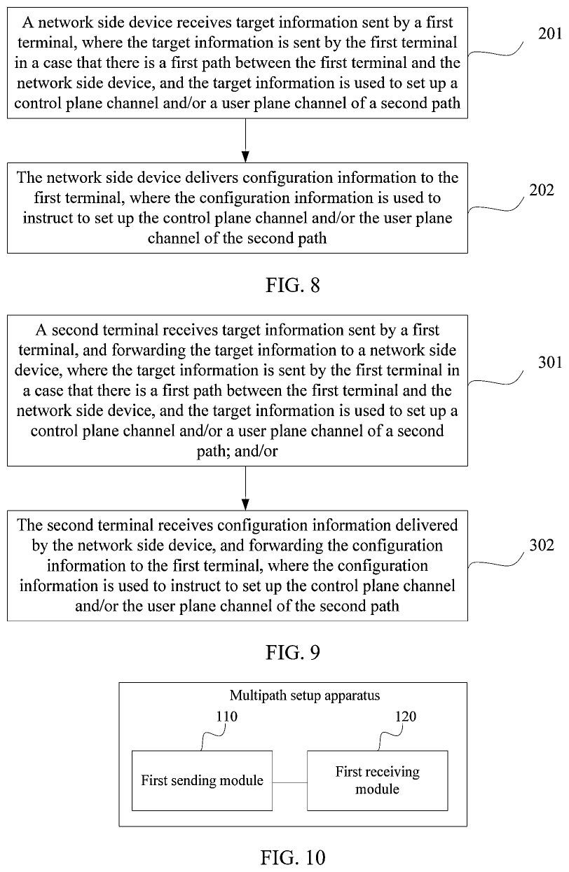

FIG. 8 is a second schematic flowchart of a multipath setup method according to an embodiment of this application. As shown in FIG. 8, the method provided in this embodiment includes the following steps.
Step 201: A network side device receives target information sent by a first terminal, where the target information is sent by the first terminal in a case that there is a first path between the first terminal and the network side device, and the target information is used to set up a control plane channel and/or a user plane channel of a second path.
Step 202: The network side device delivers configuration information to the first terminal, where the configuration information is used to instruct to set up the control plane channel and/or the user plane channel of the second path.

For example, the receiving, by a network side device, target information sent by a first terminal includes:
receiving, by the network side device, the target information sent by the first terminal by using the first path; or
receiving, by the network side device, the target information sent by the first terminal by using the second path.

For example, the delivering, by the network side device, configuration information to the first terminal includes:
delivering, by the network side device, the configuration information to the first terminal by using the first path; or
delivering, by the network side device, the configuration information to the first terminal by using the second path.

For example, the method further includes: receiving, by the network side device, configuration complete indication information sent by the first terminal.

For example, the receiving, by the network side device, configuration complete indication information sent by the first terminal includes:
receiving, by the network side device, the configuration complete indication information sent by the first terminal by using the first path; or
receiving, by the network side device, the configuration complete indication information sent by the first terminal by using the second path.

For example, the method further includes: delivering, by the network side device, a path switching instruction to the first terminal, where the path switching instruction is used to instruct the first terminal to switch a path used for current data transmission from the first path to the second path or switch a path used for current data transmission from the second path to the first path.

A specific implementation process and a technical effect of the method in this embodiment are similar to those of the method embodiment on the side of the first terminal. For details, refer to the detailed descriptions of the method embodiment on the side of the first terminal. Details are not described herein again.

FIG. 9 is a third schematic flowchart of a multipath setup method according to an embodiment of this application. As shown in FIG. 9, the method provided in this embodiment includes the following steps.
Step 301: A second terminal receives target information sent by a first terminal, and forwarding the target information to a network side device, where the target information is sent by the first terminal in a case that there is a first path between the first terminal and the network side device, and the target information is used to set up a control plane channel and/or a user plane channel of a second path; and/or
Step 302: The second terminal receives configuration information delivered by the network side device, and forwarding the configuration information to the first terminal, where the configuration information is used to instruct to set up the control plane channel and/or the user plane channel of the second path.

For example, the first path or the second path is an indirect path, and the indirect path includes a path between the first terminal and the second terminal and a path between the second terminal and the network side device; and
the receiving, by a second terminal, target information sent by a first terminal, and forwarding the target information to a network side device includes:
receiving, by the second terminal, the target information sent by the first terminal by using the path between the first terminal and the second terminal, and forwarding the target information to the network side device by using the path between the second terminal and the network side device.

For example, the first path or the second path is an indirect path, and the indirect path includes a path between the first terminal and the second terminal and a path between the second terminal and the network side device; and
the receiving, by the second terminal, configuration information delivered by the network side device, and forwarding the configuration information to the first terminal includes:
receiving, by the second terminal by using the path between the second terminal and the network side device, the configuration information delivered by the network side device, and forwarding the configuration information to the first terminal by using the path between the first terminal and the second terminal.

For example, the first path or the second path is an indirect path, and the indirect path includes a path between the first terminal and the second terminal and a path between the second terminal and the network side device; and the method further includes:
receiving, by the second terminal, configuration complete indication information sent by the first terminal by using the path between the first terminal and the second terminal, and forwarding the configuration complete indication information to the network side device by using the path between the second terminal and the network side device.

A specific implementation process and a technical effect of the method in this embodiment are similar to those of the method embodiment on the side of the first terminal. For details, refer to the detailed descriptions of the method embodiment on the side of the first terminal. Details are not described herein again.

The multipath setup method provided in the embodiments of this application may be performed by a multipath setup apparatus. In the embodiments of this application, an example in which the multipath setup apparatus performs the multipath setup method is used to describe the multipath setup apparatus provided in the embodiments of this application.

FIG. 10 is a first schematic structural diagram of a multipath setup apparatus according to an embodiment of this application. As shown in FIG. 10, the multipath setup apparatus provided in this embodiment includes:
a first sending module 110, configured to send target information to a network side device in a case that there is a first path between a first terminal and the network side device, where the target information is used to set up a control plane channel and/or a user plane channel of a second path; and
a first receiving module 120, configured to receive configuration information delivered by the network side device, where the configuration information is used to instruct to set up the control plane channel and/or the user plane channel of the second path.

For example, the target information includes a request message, and the first sending module 110 is configured to:
send the request message to the network side device in a case that there is a control plane channel of the first path between the first terminal and the network side device and a trigger condition of setting up the control plane channel and/or the user plane channel of the second path is met.

For example, the apparatus further includes:
a first setup module 130, configured to set up a user plane channel of the first path.

For example, the first path is a direct path, the second path is an indirect path, and the trigger condition includes at least one of the following: a measurement result of a direct path is less than a first threshold, a measurement result of an indirect path is greater than a second threshold, to-be-sent uplink data is obtained, and a paging message is received.

For example, the first path is an indirect path, the second path is a direct path, and the trigger condition includes at least one of the following: a measurement result of a direct path is greater than a first threshold, a measurement result of an indirect path is less than a second threshold, to-be-sent uplink data is obtained, and a paging message is received.

For example, the apparatus further includes:
a first release module 140, configured to: determine a target path according to a measurement result of the first path and/or the second path, and release the target path.

For example, the first release module 140 is configured to:
in a case that the measurement result of the first path is less than a third threshold, determine that the first path is the target path; or
in a case that the measurement result of the second path is greater than a fourth threshold, determine that the first path is the target path.

For example, the apparatus further includes:
a second setup module 150, configured to: before the first terminal sends the target information to the network side device, set up a communication connection with a second terminal, where the second path includes a path between the first terminal and the second terminal and a path between the second terminal and the network side device.

For example, the first sending module 110 is configured to:
send the request message to the network side device by using the first path; or
send the request message to the network side device by using the second path.

For example, the first sending module 110 is configured to:
send the target information to the network side device in a case that a measurement result of the first path between the first terminal and the network side device is greater than a fifth threshold.

For example, the first receiving module 120 is further configured to:
receive a path switching instruction delivered by the network side device, where the path switching instruction is used to instruct the first terminal to switch a path used for current data transmission from the first path to the second path or switch a path used for current data transmission from the second path to the first path.

For example, the apparatus further includes a second release module 160, and the second release module 160 is configured to:
release or suspend the first path in a case that the path used for the current data transmission is switched from the first path to the second path; or
release or suspend the second path in a case that the path used for the current data transmission is switched from the second path to the first path.

For example, the first sending module 110 is configured to:
send the target information to the network side device by using the first path; or
send the target information to the network side device by using the second path.

For example, the target information includes at least one of the following: a measurement result, a BSR, a SL BSR, a UAI, and SUI.

For example, the measurement result includes at least one of the following: reference signal received power RSRP and reference signal received quality RSRQ.

For example, the first receiving module 120 is configured to:
receive the configuration information delivered by the network side device by using the second path; or
receive the configuration information delivered by the network side device by using the first path.

For example, the configuration information is carried in at least one of the following:
sidelink radio bearer configuration signaling, data radio bearer configuration signaling, and packet data convergence protocol signaling.

For example, the first sending module 110 is further configured to:
after the configuration information delivered by the network side device is received, send configuration complete indication information to the network side device.

For example, the first sending module 110 is configured to:
send the configuration complete indication information to the network side device by using the first path; or
send the configuration complete indication information to the network side device by using the second path.

The apparatus in this embodiment may be configured to perform the method in any one of the foregoing method embodiments on the side of the first terminal. A specific implementation process and a technical effect of the apparatus are similar to those of the method embodiment on the side of the first terminal. For details, refer to the detailed descriptions of the method embodiment on the side of the first terminal. Details are not described herein again.

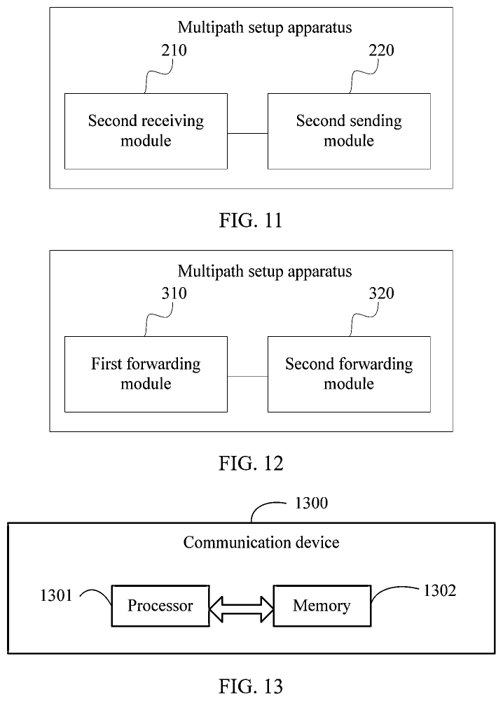

FIG. 11 is a second schematic structural diagram of a multipath setup apparatus according to an embodiment of this application. As shown in FIG. 11, the multipath setup apparatus provided in this embodiment includes:
a second receiving module 210, configured to receive target information sent by a first terminal, where the target information is sent by the first terminal in a case that there is a first path between the first terminal and a network side device, and the target information is used to set up a control plane channel and/or a user plane channel of a second path; and
a second sending module 220, configured to deliver configuration information to the first terminal, where the configuration information is used to instruct to set up the control plane channel and/or the user plane channel of the second path.

For example, the second receiving module 210 is configured to:
receive the target information sent by the first terminal by using the first path; or
receive the target information sent by the first terminal by using the second path.

For example, the second sending module 220 is configured to:
deliver the configuration information to the first terminal by using the first path; or
deliver the configuration information to the first terminal by using the second path.

For example, the second receiving module 210 is further configured to:
receive configuration complete indication information sent by the first terminal.

For example, the second receiving module 210 is configured to:
receive the configuration complete indication information sent by the first terminal by using the first path; or
receive the configuration complete indication information sent by the first terminal by using the second path.

For example, the second sending module 220 is further configured to:
deliver a path switching instruction to the first terminal, where the path switching instruction is used to instruct the first terminal to switch a path used for current data transmission from the first path to the second path or switch a path used for current data transmission from the second path to the first path.

The apparatus in this embodiment may be configured to perform the method in any one of the foregoing method embodiments on the side of the network side device. A specific implementation process and a technical effect of the apparatus are similar to those of the method embodiment on the side of the network side device. For details, refer to the detailed descriptions of the method embodiment on the side of the network side device. Details are not described herein again.

FIG. 12 is a third schematic structural diagram of a multipath setup apparatus according to an embodiment of this application. As shown in FIG. 12, the multipath setup apparatus provided in this embodiment includes:
a first forwarding module 310, configured to: receive target information sent by a first terminal, and forward the target information to a network side device, where the target information is sent by the first terminal in a case that there is a first path between the first terminal and the network side device, and the target information is used to set up a control plane channel and/or a user plane channel of a second path; and/or
a second forwarding module 320, configured to: receive configuration information delivered by the network side device, and forward the configuration information to the first terminal, where the configuration information is used to instruct to set up the control plane channel and/or the user plane channel of the second path.

For example, the first path or the second path is an indirect path, and the indirect path includes a path between the first terminal and the second terminal and a path between the second terminal and the network side device; and
the first forwarding module 310 is configured to:
receive the target information sent by the first terminal by using the path between the first terminal and the second terminal, and forward the target information to the network side device by using the path between the second terminal and the network side device.

For example, the first path or the second path is an indirect path, and the indirect path includes a path between the first terminal and the second terminal and a path between the second terminal and the network side device; and
the second forwarding module 320 is configured to:
receive, by using the path between the second terminal and the network side device, the configuration information delivered by the network side device, and forward the configuration information to the first terminal by using the path between the first terminal and the second terminal.

For example, the first path or the second path is an indirect path, and the indirect path includes a path between the first terminal and the second terminal and a path between the second terminal and the network side device; and the apparatus further includes:
a third forwarding module 330, configured to: receive configuration complete indication information sent by the first terminal by using the path between the first terminal and the second terminal, and forward the configuration complete indication information to the network side device by using the path between the second terminal and the network side device.

The apparatus in this embodiment may be configured to perform the method in any one of the foregoing method embodiments on the side of the second terminal. A specific implementation process and a technical effect of the apparatus are similar to those of the method embodiment on the side of the second terminal. For details, refer to the detailed descriptions of the method embodiment on the side of the second terminal. Details are not described herein again.

The multipath setup apparatus in the embodiments of this application may be an electronic device, for example, an electronic device having an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a network attached storage (Network Attached Storage, NAS), or the like. This is not specifically limited in this embodiment of this application.

The multipath setup apparatus provided in the embodiments of this application can implement the processes implemented in the method embodiments of FIG. 6 to FIG. 9, and achieve a same technical effect. To avoid repetition, details are not described herein again.

For example, as shown in FIG. 13, an embodiment of this application further provides a communication device 1300, including a processor 1301 and a memory 1302. The memory 1302 stores a program or an instruction that can be run on the processor 1301. For example, when the communication device 1300 is a terminal, the program or the instruction is executed by the processor 1301 to implement the steps of the foregoing multipath setup method embodiment, and a same technical effect can be achieved. When the communication device 1300 is a network side device, the program or the instruction is executed by the processor 1301 to implement the processes of the foregoing multipath setup method embodiment, and a same technical effect can be achieved. To avoid repetition, details are not described herein again.

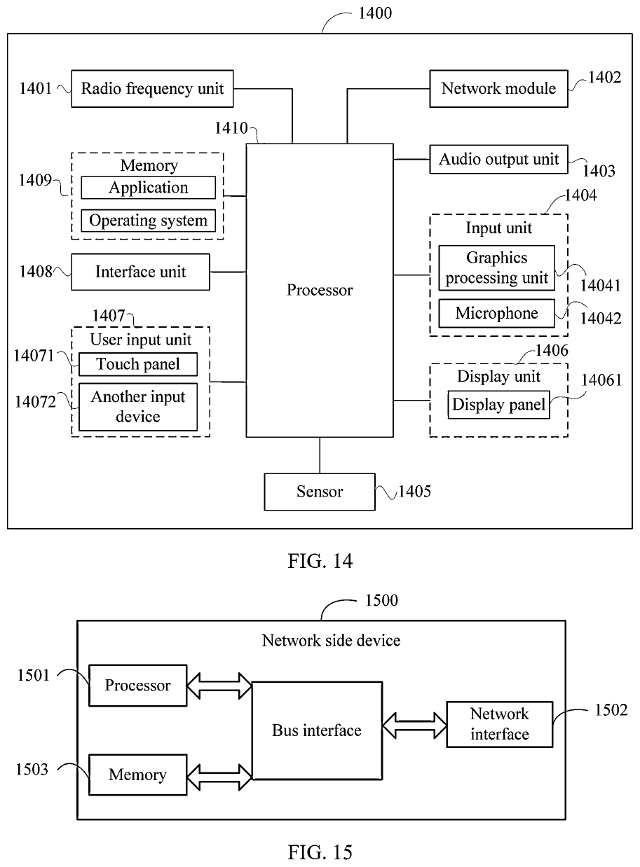

An embodiment of this application further provides a first terminal, including a processor and a memory. The memory stores a program or an instruction that can be run on the processor, and the program or the instruction is executed by the processor to implement the steps of the foregoing method embodiment on the side of the first terminal. This embodiment of the first terminal corresponds to the foregoing method embodiment on the side of the first terminal. Each implementation process and implementation of the foregoing method embodiment may be applicable to the terminal embodiment, and a same technical effect can be achieved. Specifically, FIG. 14 is a schematic structural diagram of hardware of a first terminal according to an embodiment of this application.

The first terminal 1400 includes but is not limited to components such as a radio frequency unit 1401, a network module 1402, an audio output unit 1403, an input unit 1404, a sensor 1405, a display unit 1406, a user input unit 1407, an interface unit 1408, a memory 1409, and a processor 1410.

A person skilled in the art can understand that the first terminal 1400 may further include the power supply (for example, a battery) that supplies power to each component. The power supply may be logically connected to the processor 1410 by using a power supply management system, so as to manage functions such as charging, discharging, and power consumption by using the power supply management system. The structure of the first terminal shown in FIG. 14 constitutes no limitation on the first terminal, and the terminal may include more or fewer components than those shown in the figure, or combine some components, or have different component arrangements. Details are not described herein.

It should be understood that, in this embodiment of this application, the input unit 1404 may include a Graphics Processing Unit (GPU) 14041 and a microphone 14042, and the graphics processing unit 14041 processes image data of a still image or a video that is obtained by an image capturing apparatus (for example, a camera) in a video capturing mode or an image capturing mode. The display unit 1406 may include a display panel 14061. The display panel 14061 may be configured in a form such as a liquid crystal display or an organic light-emitting diode. The user input unit 1407 includes at least one of a touch panel 14071 and another input device 14072. The touch panel 14071 is also referred to as a touchscreen. The touch panel 14071 may include two parts: a touch detection apparatus and a touch controller. The another input device 14072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1401 may transmit the downlink data to the processor 1410 for processing. In addition, the radio frequency unit 1401 may send uplink data to the network side device. Usually, the radio frequency unit 1401 includes but is not limited to an antenna, an amplifier, a transceiver, a coupler, a low noise amplifier, a duplexer, and the like.

The memory 1409 may be configured to store a software program or an instruction and various data. The memory 1409 may mainly include a first storage area for storing a program or an instruction and a second storage area for storing data. The first storage area may store an operating system, and an application or an instruction required by at least one function (for example, a sound playing function or an image playing function). In addition, the memory 1409 may be a volatile memory or a non-volatile memory, or the memory 1409 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1409 in this embodiment of this application includes but is not limited to these memories and a memory of any other proper type.

The processor 1410 may include one or more processing units. For example, an application processor and a modem processor are integrated into the processor 1410. The application processor mainly processes an operating system, a user interface, an application, and the like. The modem processor mainly processes a wireless communication signal, for example, a baseband processor. It can be understood that, in some embodiments, the modem processor may not be integrated into the processor 1410.

The processor 1410 is configured to: send target information to a network side device in a case that there is a first path between a first terminal and the network side device, where the target information is used to set up a control plane channel and/or a user plane channel of a second path; and receive configuration information delivered by the network side device, where the configuration information is used to instruct to set up the control plane channel and/or the user plane channel of the second path.

In the foregoing implementation, the control plane channel and/or the user plane channel of the second path may be set up in a case that there is the first path between the first terminal and the network side device. Signaling and/or data are/is transmitted by setting up a multipath, thereby improving communication performance in terms of reliability, throughput, and the like.

For example, the processor 1410 is configured to:
send the request message to the network side device in a case that there is a control plane channel of the first path between the first terminal and the network side device and a trigger condition of setting up the control plane channel and/or the user plane channel of the second path is met.

In the foregoing implementation, the trigger condition for setting up the control plane channel and/or the user plane channel of the second path is set. If the trigger condition is met, it is considered that a current single path (the control plane channel of the first path) used to transmit signaling and/or data cannot meet requirements for communication performance in terms of reliability, throughput, and the like. In this case, the first terminal actively requests the network side device to set up the control plane channel and/or the user plane channel of the second path. Signaling and/or data are/is transmitted by setting up a multipath, thereby improving communication performance in terms of reliability, throughput, and the like.

For example, the processor 1410 is further configured to set up a user plane channel of the first path.

In the foregoing implementation, the first terminal further sets up the user plane channel of the first path in a case that there is the control plane channel of the first path between the first terminal and the network side device, to normally process service data, so that a multipath can be set up without affecting normal processing of the service data.

For example, the first path is a direct path, the second path is an indirect path, and the trigger condition includes at least one of the following: a measurement result of a direct path is less than a first threshold, a measurement result of an indirect path is greater than a second threshold, to-be-sent uplink data is obtained, and a paging message is received.

For example, the first path is an indirect path, the second path is a direct path, and the trigger condition includes at least one of the following: a measurement result of a direct path is greater than a first threshold, a measurement result of an indirect path is less than a second threshold, to-be-sent uplink data is obtained, and a paging message is received.

For example, the processor 1410 is further configured to: determine a target path according to a measurement result of the first path and/or the second path, and release the target path.

In the foregoing implementation, after a multipath is configured, the first terminal determines the target path with relatively poor reliability according to the measurement result of the first path and/or the second path, and releases the target path, thereby improving communication performance in terms of reliability.

For example, the processor 1410 is further configured to: in a case that the measurement result of the first path is less than a third threshold, determine that the first path is the target path; or in a case that the measurement result of the second path is greater than a fourth threshold, determine that the first path is the target path.

In the foregoing implementation, if the measurement result of the first path is less than the third threshold, that is, reliability of the first path is relatively poor, the first terminal determines that the first path with relatively poor reliability is the target path; or in a case that the measurement result of the second path is greater than the fourth threshold, that is, reliability of the second path is relatively good, the first terminal reserves the second path with relatively good reliability, and determines that the first path is the target path.

For example, the processor 1410 is further configured to: before the first terminal sends the target information to the network side device, set up a communication connection with a second terminal, where the second path includes a path between the first terminal and the second terminal and a path between the second terminal and the network side device.

In the foregoing implementation, the first terminal discovers the second terminal and sets up the communication connection with the second terminal, so as to set up an indirect path.

For example, the processor 1410 is configured to:
send the request message to the network side device by using the first path; or
send the request message to the network side device by using the second path.

For example, the processor 1410 is configured to:
send the target information to the network side device in a case that a measurement result of the first path between the first terminal and the network side device is greater than a fifth threshold.

In the foregoing implementation, if the measurement result of the first path between the first terminal and the network side device is greater than the fifth threshold, it is considered that a current single path (the control plane channel of the first path) used to transmit signaling and/or data cannot meet requirements for communication performance in terms of reliability, throughput, and the like. In this case, the first terminal actively sends the target information to the network side device, to instruct to set up the control plane channel and/or the user plane channel of the second path. Signaling and/or data are/is transmitted by setting up a multipath, thereby improving communication performance in terms of reliability, throughput, and the like.

For example, the processor 1410 is further configured to receive a path switching instruction delivered by the network side device, where the path switching instruction is used to instruct the first terminal to switch a path used for current data transmission from the first path to the second path or switch a path used for current data transmission from the second path to the first path.

In the foregoing implementation, the first terminal receives the path switching instruction delivered by the network side device, and switches, according to the path switching instruction, the path used for the current data transmission from a path with relatively poor reliability to a path with relatively good reliability, thereby improving communication performance in terms of reliability.

For example, the processor 1410 is further configured to: release or suspend the first path in a case that the path used for the current data transmission is switched from the first path to the second path; or release or suspend the second path in a case that the path used for the current data transmission is switched from the second path to the first path.

In the foregoing implementation, after the path used for the current data transmission is switched from a path with relatively poor reliability to a path with relatively good reliability, the path with relatively poor reliability is released or suspended, thereby saving data transmission resources.

For example, the processor 1410 is configured to:
send the target information to the network side device by using the first path; or
send the target information to the network side device by using the second path.

For example, the target information includes at least one of the following: a measurement result, a buffer status report BSR, a sidelink buffer status report SL BSR, an uplink access indication UAI, and sidelink user equipment information SUI.

For example, the measurement result includes at least one of the following: reference signal received power RSRP and reference signal received quality RSRQ.

For example, the processor 1410 is configured to:
receive the configuration information delivered by the network side device by using the second path; or
receive the configuration information delivered by the network side device by using the first path.

For example, the configuration information is carried in at least one of the following:
sidelink radio bearer configuration signaling, data radio bearer configuration signaling, and packet data convergence protocol signaling.

For example, the processor 1410 is further configured to: after the configuration information delivered by the network side device is received, send configuration complete indication information to the network side device.

In the foregoing implementation, the first terminal sends the configuration complete indication information to the network side device, so that the network side device learns, in a timely manner, a message that the configuration information has been processed.

For example, the processor 1410 is configured to:
send the configuration complete indication information to the network side device by using the first path; or
send the configuration complete indication information to the network side device by using the second path.

An embodiment of this application further provides a second terminal, including a processor and a memory. The memory stores a program or an instruction that can be run on the processor, and the program or the instruction is executed by the processor to implement the steps of the foregoing method embodiment on the side of the second terminal. This embodiment of the second terminal corresponds to the foregoing method embodiment on the side of the second terminal. Each implementation process and implementation of the foregoing method embodiment may be applicable to this terminal embodiment, and a same technical effect can be achieved.

An embodiment of this application further provides a network side device, including a processor and a memory. The memory stores a program or an instruction that can be run on the processor, and the program or the instruction is executed by the processor to implement the steps of the foregoing method embodiment on the side of the network side device. This embodiment of the network side device corresponds to the foregoing method embodiment on the side of the network side device. Each implementation process and implementation of the foregoing method embodiment may be applicable to this embodiment of the network side device, and a same technical effect can be achieved.

Specifically, an embodiment of this application further provides a network side device. As shown in FIG. 15, a network side device 1500 includes a processor 1501, a network interface 1502, and a memory 1503. The network interface 1502 is, for example, a Common Public Radio Interface (CPRI).

Specifically, the network side device 1500 in this embodiment of the present disclosure further includes an instruction or a program that is stored in the memory 1503 and that can be run on the processor 1501. The processor 1501 invokes the instruction or the program in the memory 1503 to perform the method performed by the modules shown in FIG. 12, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing multipath setup method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing multipath setup method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing multipath setup method embodiment, and a same technical effect can be achieved. To avoid repetition, details are not described herein again.

An embodiment of this application further provides a communication system, including a first terminal, a second terminal, and a network side device. The first terminal and the second terminal may be configured to perform the steps of the foregoing multipath setup method, and the network side device may be configured to perform the steps of the foregoing multipath setup method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is an example implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A multipath setup method, comprising:
sending, by a first terminal, target information to a network side device when a first path exists between the first terminal and the network side device, wherein the target information is used to set up a control plane channel or a user plane channel of a second path; and
receiving, by the first terminal, configuration information delivered by the network side device, wherein the configuration information is used to set up the control plane channel or the user plane channel of the second path.

2. The multipath setup method according to claim 1, wherein the target information comprises a request message, and the sending, by the first terminal, the target information to the network side device when the first path exists between the first terminal and the network side device comprises:
sending, by the first terminal, the request message to the network side device when the control plane channel of the first path exists between the first terminal and the network side device and a trigger condition of setting up the control plane channel or the user plane channel of the second path is met.

3. The multipath setup method according to claim 2, further comprising:
setting up, by the first terminal, the user plane channel of the first path.

4. The multipath setup method according to claim 2, wherein the first path is a direct path, the second path is an indirect path, and the trigger condition comprises at least one of the following: a measurement result of the direct path is less than a first threshold, a measurement result of the indirect path is greater than a second threshold, a to-be-sent uplink data is obtained, or a paging message is received.

5. The multipath setup method according to claim 2, wherein the first path is an indirect path, the second path is a direct path, and the trigger condition comprises at least one of the following: a measurement result of the direct path is greater than a first threshold, a measurement result of the indirect path is less than a second threshold, to-be-sent uplink data is obtained, or a paging message is received.

6. The multipath setup method according claim 2, wherein before the sending, by the first terminal, the target information to the network side device, the method further comprises:
setting up, by the first terminal, a communication connection with a second terminal, wherein the second path comprises a path between the first terminal and the second terminal and a path between the second terminal and the network side device.

7. The multipath setup method according to claim 1, wherein the sending, by the first terminal, the target information to the network side device when the first path exists between the first terminal and the network side device comprises:
sending, by the first terminal, the target information to the network side device when a measurement result of the first path between the first terminal and the network side device is greater than a fifth threshold.

8. The multipath setup method according to claim 7, further comprising:
receiving, by the first terminal, a path switching instruction delivered by the network side device, wherein the path switching instruction is used to instruct the first terminal to switch a path used for current data transmission from the first path to the second path or switch the path used for the current data transmission from the second path to the first path.

9. The multipath setup method according to claim 8, further comprising:
releasing or suspending, by the first terminal, the first path when the path used for the current data transmission is switched from the first path to the second path; or
releasing or suspending, by the first terminal, the second path when the path used for the current data transmission is switched from the second path to the first path.

10. The multipath setup method according to claim 7, wherein the sending, by the first terminal, the target information to the network side device comprises:
sending, by the first terminal, the target information to the network side device using the first path; or
sending, by the first terminal, the target information to the network side device using the second path.

11. The multipath setup method according to claim 7, wherein the target information comprises at least one of the following: a measurement result, a Buffer Status Report (BSR), a Sidelink Buffer Status Report (SL BSR), an Uplink Access Indication (UAI), or Sidelink User Equipment Information (SUI).

12. The multipath setup method according to claim 1, wherein the configuration information is carried in at least one of the following: sidelink radio bearer configuration signaling, data radio bearer configuration signaling, or packet data convergence protocol signaling.

13. The multipath setup method according to claim 1, wherein after the receiving, by the first terminal, the configuration information delivered by the network side device, the method further comprises:
sending, by the first terminal, configuration complete indication information to the network side device.

14. A multipath setup method, comprising:
receiving, by a network side device, target information sent by a first terminal, wherein the target information is sent by the first terminal when a first path exists between the first terminal and the network side device, and the target information is used to set up a control plane channel or a user plane channel of a second path; and
delivering, by the network side device, configuration information to the first terminal, wherein the configuration information is used to set up the control plane channel or the user plane channel of the second path.

15. The multipath setup method according to claim 14, wherein the receiving, by the network side device, the target information sent by the first terminal comprises:
receiving, by the network side device, the target information sent by the first terminal using the first path; or
receiving, by the network side device, the target information sent by the first terminal using the second path.

16. The multipath setup method according to claim 14, wherein the delivering, by the network side device, the configuration information to the first terminal comprises:
delivering, by the network side device, the configuration information to the first terminal using the first path; or
delivering, by the network side device, the configuration information to the first terminal using the second path.

17. The multipath setup method according to claim 14, further comprising:
receiving, by the network side device, configuration complete indication information sent by the first terminal.

18. The multipath setup method according to claim 14, further comprising:
delivering, by the network side device, a path switching instruction to the first terminal, wherein the path switching instruction is used to instruct the first terminal to switch a path used for current data transmission from the first path to the second path or switch the path used for the current data transmission from the second path to the first path.

19. A multipath setup method, comprising:
receiving, by a second terminal, target information sent by a first terminal, and forwarding the target information to a network side device, wherein the target information is sent by the first terminal when a first path exists between the first terminal and the network side device, and the target information is used to set up a control plane channel or a user plane channel of a second path;
or receiving, by the second terminal, configuration information delivered by the network side device, and forwarding the configuration information to the first terminal, wherein the configuration information is used to set up the control plane channel or the user plane channel of the second path.

20. The multipath setup method according to claim 19, wherein the first path or the second path is an indirect path, and the indirect path comprises a path between the first terminal and the second terminal, and a path between the second terminal and the network side device,
the method further comprises:
receiving, by the second terminal, configuration complete indication information sent by the first terminal using the path between the first terminal and the second terminal, and forwarding the configuration complete indication information to the network side device using the path between the second terminal and the network side device.
